(19) United States
(12) Patent Application Publication
(10) Pub. No.: US 2002/0181089 A1
(43) Pub. Date: Dec. 5, 2002

(54) Laser with selectable wavelength

(76) Inventors: Dirk Muhlhoff, Kunitz (DE); Michael Kempe, Kunitz (DE)

Correspondence Address: Douglas J. Christensen, PATTERSON, THUENTE, SKAAR & CHRISTENSEN, 4800 IDS Center, 80 South Eighth Street, Minneapolis, MN, 55402, US

(21) Appl. No.: 10/160,993

(22) Filed: May 31, 2002

(30) Foreign Application Priority Data
Jun. 1, 2001 (DE) 101 27 014.3

(51) Int. Cl. H01S 3/00

(52) U.S. Cl. 359/346

(57) ABSTRACT

In order to enable adjustment of the output wavelength of a laser, there is provided a laser comprising a laser-active material (100), which is excitable at not less than two laser wavelengths to emit laser beams with a gain, said gain being different at the two laser wavelengths, a resonator comprising two end mirrors (102, 110; 130, 132), in which resonator the laser-active material (100) is arranged and which resonator is adapted, with respect to its resonance conditions, to the laser wavelength having the lower gain, wherein one of said end mirrors (110, 132) is partially transmissive for radiation at said laser wavelengths, an output mirror (116), which is partially transmissive for said laser wavelengths and is arranged following the partially transmissive end mirror (110, 132) in the optical path, an optical element (112, 120), which is arranged between the partially transmissive end mirror (110, 132) and the output mirror (116), on which radiation is incident at said laser wavelengths and which has an optical property effecting a wavelength selection of the output laser beam (118) output by the output mirror (116).

### FIELD OF THE INVENTION

The invention relates to a laser comprising a laser-active medium, which is excitable at not less than two laser wavelengths to emit radiation, a resonator having two mirrors, in which resonator the laser-active medium is arranged, said laser having selectable wavelengths for the output laser beam.

### BACKGROUND OF THE INVENTION

Although multi-purpose lasers are known, they generally emit output radiation laser beams at a single wavelength only. However, in many cases it is required to switch the output laser beam between different wavelengths.

In this connection, the prior art discloses fiber lasers which can emit radiation with a selectable wavelength. However, these known ways of wavelength switching are too slow for many applications. A further problem of the known switchable lasers consists in their lack of stability and their low output power, when the laser is operated on emission lines of the laser-active material having a low gain. Such lack of stability generally requires closed-loop control, which, however, additionally slows down the switching between the different wavelengths.

U.S. Pat. No. 5,159,601 discloses a fiber laser whose output mirror is adjustable with respect to its wavelength transmission properties, for example by electrical heating.

U.S. Pat. No. 5,691,999 discloses a fiber laser whose fiber is adjustable with respect to its resonance properties by mechanical compression, so that adjustability of the wavelength of the output laser beam is achieved. Moreover, this document describes reflection elements for constructing a resonator, which elements are electrically adjustable with respect to their reflective properties.

In order to provide for an output laser beam with selectable wavelengths, it could basically be conceivable to switch between the beams of several lasers. However, this entails great expenditure and, in spite of an almost doubled expenditure, does not always guarantee that the laser beam will be emitted under identical conditions, for example that it will impinge on a sample at the same location and at the same angle.

Therefore, it is an object of the invention to provide a simple laser allowing rapid switching of the wavelength of the output laser beam.

### SUMMARY OF THE INVENTION

This object is achieved by a laser comprising a laser-active material, which is excitable at not less than two laser wavelengths to emit radiation, the gain being generally different at the two or more laser wavelengths, a resonator comprising two end mirrors, in which resonator the laser-active material is arranged and which resonator, with respect to its feedback conditions, is designed for the laser wavelength having the lower gain, with one of said end mirrors being partially transmissive for radiation at said laser wavelengths, an output mirror following the partially transmissive end mirror in the optical path to partially transmit said laser wavelengths, an optical element arranged between said partially transmissive end mirror and said output mirror, on which element radiation is incident at said laser wavelengths and which has an optical property for effecting a wavelength selection of the output laser beam output at the output mirror. The resonator is preferably designed for the resonance and feedback condition required for the stimulated laser emission at the laser wavelength having the lowest gain in the laser-active material. The optical element selects the output wavelength of the laser to be exactly this laser wavelength excited in the laser-active material by introducing increased losses for all other wavelengths. The wave spectrum of the output laser beam is changed by altering, exchanging or removing the optical element. Without said element, an output laser beam is possible which comprises light of the laser wavelength having the lowest gain in the laser-active material, while, under suitable resonance conditions adjustable by means of the output mirror, further laser wavelengths may also exit simultaneously. Thus, it is very easy to select the wavelength of the output laser beam exiting at the output mirror; in particular, the resonator, in which the laser-active material is arranged, need not be adjusted in order to change the output wavelength, which would require high precision of adjustment due to the sometimes rather narrow-band resonance conditions.

This concept has the advantage that the optical element, which tunes the wavelength of the emitted output light, is not an element critical to the adjustment of the resonance property.

Since the resonator is adapted, with respect to its resonance conditions, to the laser wavelength having the lower gain, the output power for this laser wavelength is maximized. For laser wavelengths at which the laser-active material has a higher gain, comparable power outputs are usually obtainable in spite of higher losses.

The optical conditions merely need to be such that, due to the optical properties of the optical element, the desired output wavelength(s) between the one end mirror of the resonator and the partially transmissive end mirror as well as the output mirror, is (are) still subject to a sufficient gain.

The laser-active material needs to be excitable for emission at not less than two laser wavelengths. A laser-active material emitting at laser wavelengths which are spectrally very distinct from each other is particularly preferred. In this case, the switching between different output wavelengths by altering the optical element is particularly insensitive to tolerances. A particularly cost-effective and easy-to-handle laser-active material is an optical fiber, whose core is excitable for laser emission. This is usually achieved by doping the core of a fiber with a suitable material enabling stimulated emission when being appropriately excited.

Particularly easy switching of the output wavelength during laser operation is achieved by an optical element which is adjustable with respect to the wavelength dependence of its optical property. The output wavelength is then switched by altering said optical property.

It is essential for the optical element that its optical properties determine the output wavelength, as discussed above. A particularly simple embodiment of the optical element is provided in the form of a filter disposed in the optical path.

If the laser wavelength having the lower gain is to be selected as the output wavelength using such filter, the degree of transmission of the filter should accordingly be higher for beams of the laser wavelength having the lowest gain than for other laser wavelengths. Such filters are known, e.g. in the form of edge filters. If the filter is arranged in the optical path, the laser wavelength having the lowest gain emerges at the output mirror. If the filter is removed from the optical path, other laser wavelengths having greater gains will dominate.

Switching is particularly easy when the filter is removable from the optical path, e.g. when it is pivotably arranged in the optical path. By swiveling into and out of the optical path, it will then effect switching of the output wavelength. Instead of a pivoting motion, a sliding motion is, of course, also conceivable to introduce a filter into the optical path. Such mechanical structure may be configured, for example, in the manner of a slide holder. Since the position of the filter in the optical path is not critical to the configuration chosen according to the invention, the precision required for the mechanical switching in view of mechanical vibrations or tolerances of the filter is easily realized without having the danger of negative effects on the stability of laser operation.

In an alternative embodiment, the optical element may also be provided as a controllable dichroitic reflector.

To allow switching between several output wavelengths, the optical element is conveniently designed in the form of several filters. In this case, different degrees of transmission of the filters may be provided for different wavelengths. The different filters may be changed mechanically in order to switch the wavelengths of the output laser light in the optical path. For particularly fast switching, the mechanical construction may be provided with a transport as known from film projection. Those filters which are to be moved sequentially into the optical path are then arranged in the desired order in the manner of a film loop.

In a particularly easy-to-realize further embodiment, several filters are arranged as sectors of a wheel which is rotatably arranged in the optical path. The wavelength selection of the output laser beam is then effected simply by rotating this filter wheel. This allows attaining very fast switching of the wavelength of the output laser beam. For speeds in the order of 2,000 rotations per minute and for 100 sectors per filter wheel, switching times in the order of 300 μs are achieved.

Shorter switching times for switching between individual output wavelengths are achieved with very little effort by a preferred further embodiment of the invention, wherein the optical element is adjustable with respect to its wavelength dependence by electrical control. The assembly becomes particularly simple when the optical element effects the wavelength selection through reflection and transmission properties which may be electrically influenced. Modulators which make use of the Kerr or Faraday effects are particularly suitable to this end, with acousto-optical modulators being particularly suitable because of their small size.

Therefore, the optical element preferably comprises an acousto-optical modulator having adjustable transmission or reflection properties. The effect of an acousto-optical modulator is wavelength-dependent, allowing electrically adjustable wavelength selection for unpolarized or polarized light. The Kerr or Faraday effects are polarization-dependent and thus applicable to polarized laser beams.

If an optical fiber is used as the laser-active medium, it is particularly convenient to attach the end mirrors securely on the fiber ends, thus achieving a robust structure.

In a further preferred embodiment of the invention, the end mirror which is partially transmissive for radiation at the laser wavelengths may be made intransparent to pump light which is used for emission in the laser-active medium. Thus, it is the generated radiation which is output at the partially transmissive end mirror at the laser wavelengths, and not the pump light, so that maximum use is made of the latter to stimulate laser operation. This increases efficiency and provides more laser power, e.g. also for increased stability by intensity control.

If the optical element allows to output radiation at more than one laser wavelength, the spectral composition of the output radiation may be influenced in an advantageous and easy manner by an output mirror having different degrees of reflection, and thus also of transmission, at the laser wavelengths.

Further, the spectral composition is also controllable with given end and output mirrors by changing the resonator condition of the output mirror—e.g. by changing its position or its optical properties.

It is possible in all arrangements, without any problem, to design the resonator such that the output radiation has the same spatial emission characteristics, regardless of the wavelength. In particular, the point of exit from the resonator, the propagation direction, the beam diameter and the beam divergence are identical.

The invention will be explained in further detail below by way of example and with reference to the drawings, wherein:

### BRIEF DESCRIPTION OF THE DRAWINGS

FIG. 1 shows the basic structure of a fiber laser comprising an optical element for wavelength selection arranged outside the resonator;

FIG. 2 shows a similar structure as FIG. 1, but comprising an acousto-optical modulator as optical element;

FIG. 3 shows a similar structure as FIG. 1, but with the output laser beam being output on the pump light input side, and

FIG. 4 shows a set of characteristic curves for the embodiment of FIG. 1.

### DETAILED DESCRIPTION OF THE PREFERRED EMBODIMENTS OF THE INVENTION

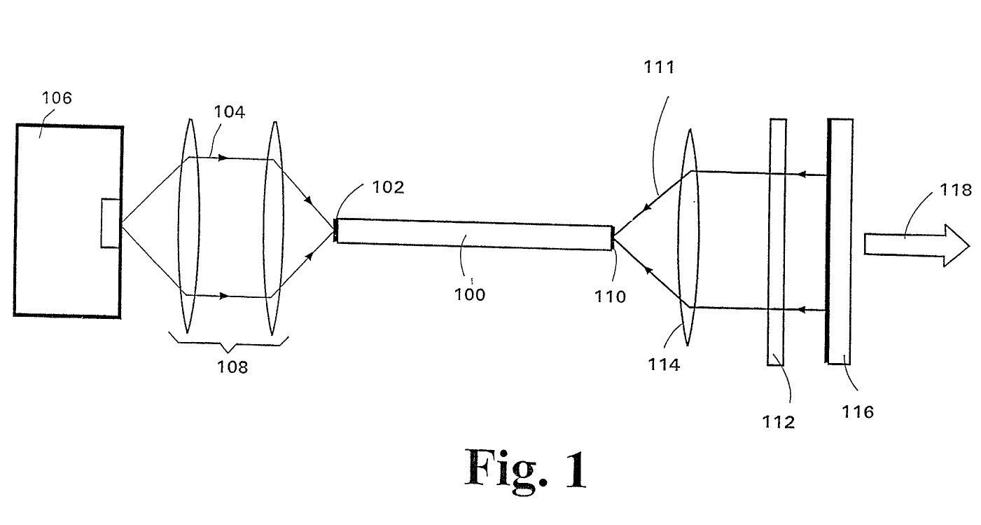

FIG. 1 shows a fiber laser comprising a fiber 100, whose core is doped with a material allowing stimulated emission upon suitable excitation.

The use of different doping substances in the core of such a fiber 100 allows to produce, at different respective laser wavelengths, laser transitions associated to the atom excitation levels. However, it is also possible to use different laser lines of one single doping substance in order to obtain different laser wavelengths. This is common, e.g., in so-called upconversion fiber lasers.

At one end, the fiber 100 has an end mirror 102 which was produced, in this embodiment, by vapor deposition and is preferably formed as a dielectric layer system transmitting the pump light. The end mirror 102 exhibits high reflectivity, if possible at more than 95%, for the laser wavelengths at which the core material of the fiber 100 is excitable for stimulated emission. Pump light 104 is generated using an infrared laser diode 106 and is introduced into the core of the fiber 100 via the end mirror 102 by an optical system 108, consisting of lenses which first parallelize the pump light emitted by the infrared laser diode 106 and then focus it on one end of the fiber 100. A further end mirror 110, which fully reflects the wavelength of the pump light, but only partially reflects radiation at the laser wavelengths, is provided at the end of fiber 100 opposite the end mirror 102. The end mirrors 102 and 110 at the fiber ends thus form a resonator which, together with the end mirrors 102 and 110, is tuned to that particular laser wavelength at which the material of the fiber 100 has the lowest gain.

Due to the coating reflecting pump light, the pump light is used in the fiber 100 for laser excitation at maximum efficiency. The core material of the fiber 100 is excitable for stimulated emission at several laser wavelengths. The gain in the material of the fiber core is, of course, not the same for all laser wavelengths, and there is one particular laser wavelength at which the gain is at a minimum.

Now, for excitation of the laser process in the fiber 100, the resonator is tuned to that laser wavelength at which the core material of the fiber 100 has the lowest gain. For this laser wavelength, the end mirror 110 has the highest degree of reflection; on the other hand, radiation at other laser wavelengths is less strongly reflected by the end mirror 110. For the laser wavelength having the lowest gain, the degree of reflection is so high that there is always sufficient feedback in the fiber 100 to enable laser operation; for the other laser wavelengths, the feedback is lower, but the gain is higher.

If pump light 104 is introduced, a laser beam 111 exits at the end mirror 110. Said beam is collimated by an optical system 114, represented by one single lens here, and projected to a partially transmissive output mirror 116. Alternatively, the optical system 114 may also image the end mirror 110 to the output mirror 116. The latter is partially transmissive for radiation at the laser wavelengths so that an output laser beam 118 is output there.

An optical element, which shall be explained in more detail hereinafter, is provided for wavelength selection between the partially transmissive end mirror 110 and the output mirror 116.

The partially reflective coating of the output mirror 116 allows part of the laser beam 111 to be fed back into the fiber 100 via the optical element 112, the optical system 114 and the end mirror 110.

Since the laser line at which the fiber 100 shows laser operation is relatively broad, the combination of the optical system 114, the optical element 112 and the output mirror 116 is not critical for the resonance condition with respect to the phase matching. Thus, the output mirror 116 may generally be moved up to several millimeters without affecting the laser process.

The aforementioned adjustment of the fiber 100 and the end mirrors 102 and 110 to the wavelength having the lowest gain allows to obtain stable laser operation at all laser wavelengths that can be generated in the fiber 100.

The optical element 112, which is presently provided as a filter, serves to select a wavelength. If said element is not arranged in the optical path between the partially transmissive end mirror 110 and the output mirror 116, the output laser beam 118 contains a mixture of all laser wavelengths present upon excitation by the pump light 104 in fiber 100. According to the nature of the active medium, the gain, and the feedback, only some of the usable laser wavelengths may be emitted in the present case. In order to switch the wavelength of the output laser beam 118 in the embodiment of FIG. 1, the filter is introduced between the end mirror 110 and the output mirror 116 in such a manner that it may be removed from the optical path. The filter has a wavelength-selective effect in that it allows transmission of the laser beam 111 in a different manner for each individual laser wavelength. A filter holder is movably provided in the optical path between the end mirror 110 and the output mirror 116. This is achieved, in FIG. 1, by a sliding mechanism of the kind known from slide projectors. Alternatively, the filter 112 may be disposed on a film and transported in the optical path between the partially transmissive end mirror 110 and the output mirror 116 in the manner of a film transport known from film projection. Such design allows the output laser beam 118 to be adjusted, in particular sequentially, to the same wavelengths at all times, using several different filters.

In a further embodiment not shown in FIG. 1, different filters 112 are disposed on sectors of a wheel, which is rotatably arranged in the optical path. The switching of the output laser beam 118 to different wavelengths is then effected by rotating the wheel. The axis of rotation of the wheel conveniently extends approximately parallel to the propagation direction of the laser beam 111.

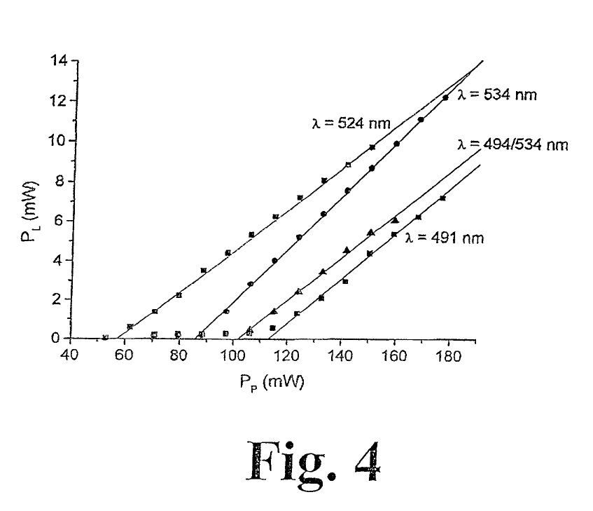

FIG. 4 shows results of measurements for a fiber laser in a setup according to FIG. 1. A single-mode laser diode having a wavelength of 835 nm is used as the pump laser 106. The maximum power corresponds to 200 mW, of which approximately 65% are introduced into the core of the fiber 100 via the end mirror 102. The fiber 100 is a ZBLAN fluoride optical fiber doped with p³⁺ (3,000 ppm) and Yb³⁺ (20,000 ppm), having a core diameter of 3.5 μm, a numerical aperture of 0.2 cm, and a length of 30 cm. The mirrors are coated as follows, with R denoting the degree of reflection:

End mirror 102:

highly reflective (HR) at 491 nm to 535 nm (R>98%),

partially reflective (PR) at 605 nm and 635 nm (R=6%),

PR at 835 nm (R=8%);

End mirror 110:

PR at 491 nm (R=95%),

PR at 524 nm (R=15%) and 535 nm (R=65%),

PR at 605 nm (R=15%) and 635 nm (R=10%),

HR at 835 nm (R>99%);

Output mirror 116:

Version I

PR at 491 nm (R<96%),

PR at 524 nm (R=70%),

PR at 535 nm (R=28%);

Version II

PR at 491 nm (R<96%),

PR at 524 nm (R=20%),

PR at 535 nm (R=20%);

The optical system 114 is an achromate having a numeric aperture of 0.55 and a focal length of 4.5 mm, and was employed such that the focus was at a distance of 14 cm from the end mirror 110.

The filter 112 is an edge filter which is highly reflective at wavelengths of more than 520 nm and fully transmitting at wavelengths below 500 nm. The active fiber core pumped by the laser diode 106 is designed for fluorescence at the laser transitions of 491 nm, 520 nm to 535 nm, 605 nm, 635 nm, due to the aforementioned doping substances and the wavelength of excitation. The highly reflective coating of the end mirror 110 for the pump light allows a double passage of the pump light and, consequently, effective absorption. As a result of the low reflectivity of the end mirror 110 and of the output mirror 116 in the green to red spectral ranges, laser excitation without external back reflection is achieved only at the wavelength of 491 nm. However, the output at the end mirror 102 is so high in the red spectral range that, even with external feedback through the output mirror 116 at 605 nm and 635 nm, no laser operation is achieved. The feedback through the end mirror 102 in the green spectral range is sufficient, however, to achieve laser operation in the wavelength range of from 525 to 535 nm by selecting a suitable coating for the output mirror 116. This external feedback may be prevented by the optical element 112 so that, as a consequence, laser operation only occurs at 491 nm.

FIG. 4 shows characteristic curves of the fiber laser of FIG. 1. Output power P_{L} is represented as a function of pumping power P_{P}. Switchable laser operation at 524 nm and 491 nm was achieved using Version I of the output mirror 116, and at 534 nm, 491 nm and at 494 nm/534 nm, simultaneously, using Version II of the output mirror 116. Switching between the green and blue wavelengths of the output laser beam 118 was effected by moving the filter 112. The simultaneous emission in the blue and green spectral ranges was achieved by tilting the output mirror 116. The feedback is fine-tuned so that the emission at both wavelengths, 534 nm and 494 nm, occurs with the same power in the output laser beam 118. Tilting of the mirror 116 allows adjustment of the individual components of power at the laser wavelengths in the output laser beam 118.

The achromatic design of the resonator, in particular the wavelength-independent imaging properties of the optical system 114, allows to attain identical beam properties of the output laser beam (propagation direction, beam diameter, divergence) for all wavelengths.

In a further embodiment, an electrically controllable element is used instead of mechanically changeable optical elements 110. To this end, use may be made of all electrically controllable physical effects that are wavelength- or polarization-dependent. Among the latter, the Kerr or Faraday effects are particularly relevant, but their application requires a polarized laser beam 111. Such beam may be obtained by providing a polarizing element either within the fiber 100, or between the fiber 100 and the end mirror 110, or between the end mirror 110 and the optical element 112. Said polarization may also be achieved by applying pressure to the fiber 100 or by looping the fiber 100. By thus changing the wavelength-dependent attenuation in birefringent materials, a wavelength selection may be achieved electrically or magnetically, using a suitably controllable optical element 112.

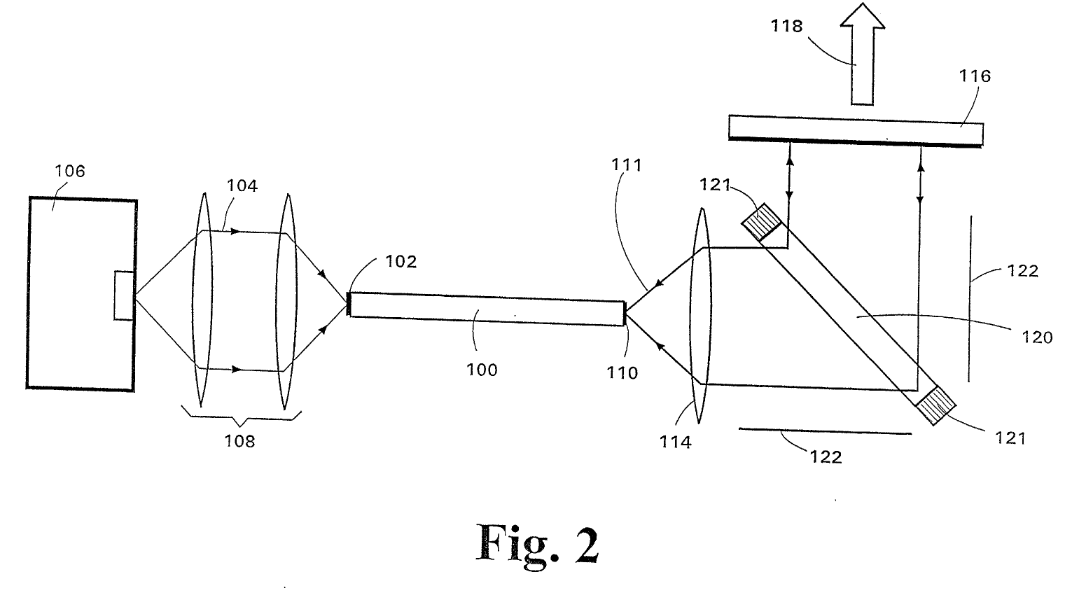

FIG. 2 shows a further embodiment wherein the optical property used is the acousto-optical effect, which is polarization-independent, but wavelength-dependent. Said effect is based on the fact that an ultrasonic wave produces periodic densification of a material. This densification may be employed as a diffraction grating for deflecting a laser beam. In the embodiment of FIG. 2, the ultrasonic wave is particularly conveniently generated by a piezo crystal.

A crystal 120, which experiences a large increase of the refractive index under pressure, is provided as the optical element in the embodiment of FIG. 2. If a standing wave is introduced into the crystal 120 by piezo elements 121 suitably attached to the crystal 120, a standing acoustic wave will be generated, which is effective as an optical grating for radiation. Thus, use can be made of the Bragg reflection.

Diffraction phenomena will then lead to a deflection of the beam 111 incident on the electric crystal 120. Therefore, the crystal 120 depicted in FIG. 2 is at an angle to the axis of propagation of the beam parallelized by the optical system 114. Thus, the deflection will be effective as a diffraction in only one order of diffraction. In order to make use also of diffraction maxima of zero order to reduce losses, additional mirrors 122 are provided which back-reflect the radiation derived from such diffraction maxima either to the output mirror 116 or to the optical element 114.

Thus, the wavelength of the beam directed to the output mirror 116 may be adjusted via the electrical control of the piezo elements 121. This allows a selection to be made among the different laser wavelengths exiting at the partially transmissive end mirror 110. Since the control of the piezo elements 121 may be effected very fast, the switching time is very short. The switching times thus attainable are in the microsecond range.

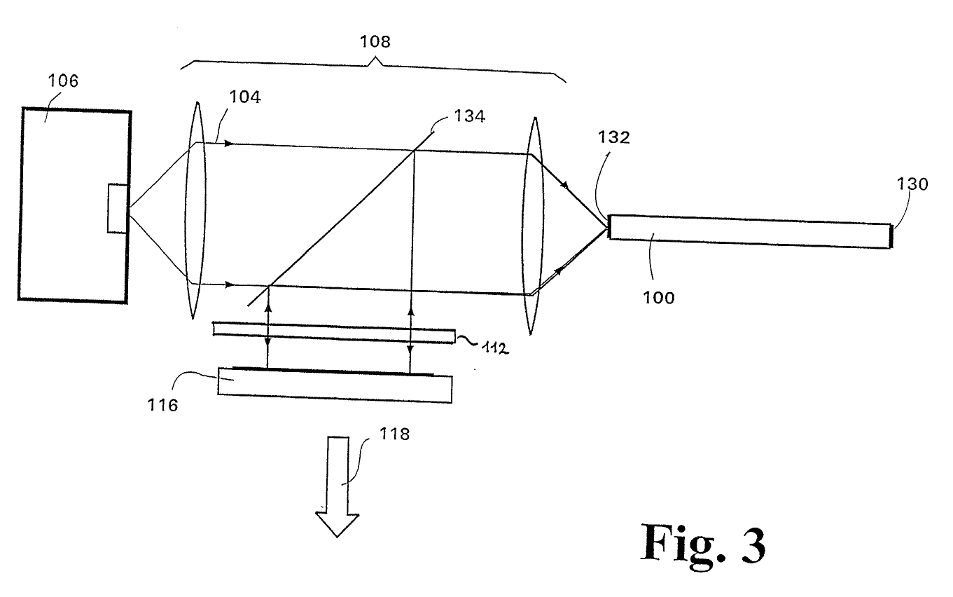

FIG. 3 shows a further embodiment, wherein the pump beam 104 and the laser beam are input and output, respectively, at the same end mirror of the fiber 100. This is achieved by providing one end of the fiber 100 with an end mirror 130, which is fully reflective for pump light and for radiation at the laser wavelengths. In addition to dielectric layers, said mirror may contain corresponding metallizations, e.g. with aluminum or silver.

The mirror 132 arranged opposite the end mirror 130 is partially transmissive for both the pump light and the laser light. Again, the pump light 104 is generated by the laser diode 106 and introduced to the core of the fiber 100 through an optical system 108 via the end mirror 132. Since the laser beam also exits at the partially transmissive end mirror 132, said beam must be separated from the pump light. For example, a polarizing beam splitter is suitable to this end. However, the embodiment of FIG. 3 uses a mirror 134, which is arranged in the optical path between the lenses of the optical system 108 and deflects the generated laser beam, but not the pump light. This is achieved by suitable dielectric coating of the mirror 132. This is easily feasible, in particular, when the fiber 100 is used as an upconversion fiber laser, in which a large frequency difference between the pump beam and the laser beam exists.

In this embodiment, the optical element for selection of the laser wavelength is a mirror 134. The wavelength selection may be effected by mechanically changing the mirror, but preferably by a filter 112 (not shown) in the optical path between the end mirror 132 and the mirror 134. The electrical control using a crystal 120 in the embodiment of FIG. 2 is, of course, possible as well.

Although the present invention has been described with reference to the preferred embodiments, workers skilled in the art will recognize changes may be made in form and detail without departing from the spirit and scope of the invention.

What is claimed is:

1. A laser comprising:
a laser-active material (100), which is excitable at not less than two wavelengths to emit laser beams, wherein the laser-active material has a different gain for each of said wavelengths,
a resonator comprising two end mirrors (102, 110; 130, 132), in which resonator the laser-active material (100) is located and which resonator is adapted, with respect to its resonance conditions, to a wavelength of said wavelengths which has the lowest gain, wherein one of said end mirrors (110, 132) is partially transmissive for radiation at said laser wavelengths,
an output mirror (116), which is partially transmissive for said laser wavelengths and is arranged in the optical path following the partially transmissive end mirror (110, 132),
an optical element (112, 120), which is arranged between the partially transmissive end mirror (110, 132) and the output mirror (116), on which radiation is incident at all of said laser wavelengths and which has an optical property effecting a wavelength selection of the output laser beam (118) output by the output mirror (116) to at least one of said laser wavelengths.

2. The laser as claimed in claim 1, wherein the optical property of the optical element (112, 120) depends on the laser wavelength.

3. The laser as claimed in claim 2, wherein the optical element (112, 120) is adjustable with respect to the wavelength dependance of its optical property.

4. The laser as claimed in any one of claims 2 or 3, wherein the optical element is a filter (112).

5. The laser as claimed in claim 4, wherein the degree of transmission of the filter (112) is greater for radiation of the laser wavelength having the lowest gain than for other laser wavelengths.

6. The laser as claimed in any one of claims 4 or 5, wherein the filter (112) is removable from the optical path.

7. The laser as claimed in any one of claims 4 to 6, comprising several filters (112).

8. The laser as claimed in claim 4 or 7, wherein the filter(s) (112) is/are mechanically exchangeable for switching the wavelength of the output laser beam (118) in the optical path.

9. The laser as claimed in claim 8, wherein the filters (112) are provided as sectors of a wheel which is rotatable in the optical path.

10. The laser as claimed in any one of claims 1 to 3, wherein the optical element (120) is adjustable by electrical control with respect to its optical property causing the wavelength selection.

11. The laser as claimed in claim 10, wherein the optical element comprises an acousto-optical modulator (120) having selectable reflection properties.

12. The laser as claimed in any of the preceding claims, wherein the laser-active medium is provided as an optical fiber (110) and wherein the end mirrors (102, 110; 130, 132) are securely attached to the fiber ends.

13. The laser as claimed in any of the preceding claims, wherein the output mirror (116) has a different degree of reflection for said laser wavelengths.

14. The laser as claimed in any of the preceding claims, wherein the degree of reflection at which the radiation is reflected back to the partially transmissive end mirror (110, 113) at the respective wavelengths is adjustable by changing the output mirror (116).
